(19) United States
(12) Patent Application Publication
(10) Pub. No.: US 2023/0010248 A1
(43) Pub. Date: Jan. 12, 2023

(54) SMART FABRIC FOR ITEM VERIFICATION AND AUTHENTICATION

(71) Applicant: Microsoft Technology Licensing, LLC, Redmond, WA (US)

(72) Inventors: Evelina BARHUDARIAN, Renton, WA (US); Alemayehu SEYED, Mercer Island, WA (US)

(21) Appl. No.: 17/459,688

(22) Filed: Aug. 27, 2021

Related U.S. Application Data
(60) Provisional application No. 63/220,356, filed on Jul. 9, 2021.

(51) Int. Cl. G06Q 30/00; G06F 16/22; H04W 76/11

(52) U.S. Cl. CPC G06Q 30/018; G06F 16/2255; H04W 76/11

(57) ABSTRACT

A service computing system (server) has a storage stored thereon multiple records associated with multiple items. Each item has a piece of smart fabric fixed thereon. Each record stores at least a unique identifier of a piece of smart fabric and a unique identifier of a verification and authentication device associated with the item. The server is configured to receive a verification request from a mobile device containing at least one of a unique identifier of a piece of smart fabric associated with an item, or a unique identifier of a verification and authentication device associated with the item. In response to determining that the identifier of the smart fabric or the identifier of the verification and authentication device is associated with a record, the server generates a token and causes the token to be received by the verification and authentication device, causing the verification and authentication device to transmit data associated with the token to the piece of smart fabric for authentication.

### CROSS-REFERENCE TO RELATED APPLICATION

This application claims the benefit of U.S. Provisional Application No. 63/220,356, filed Jul. 9, 2021, the entire contents of which are herein incorporated by reference.

### BACKGROUND

Counterfeit luxury goods, such as (but not limited to handbags), cause serious damages to the luxury brands. Recently, fake items are getting more and more realistic. To the untrained eyes, the fake items often look just like the genuine items, and even trained authenticators cannot always clearly differentiate the fake items and the genuine items. Further, the luxury goods resale market has grown online, through which the fakes items might be given additional lives and markets for consumption, further damaging the luxury brands.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

The embodiments described herein are related to a system including a piece of smart fabric embedded in an item (e.g., a luxury good), a verification and authentication device, a service computing system, and/or a mobile device for allowing the verification of whether the item is an authentic item.

The service computing system has access to a plurality of records associated with a plurality of items. Each item has a piece of smart fabric fixed thereon. Each of the plurality of records is configured to store at least a unique identifier of a piece of smart fabric and a unique identifier of a verification and authentication device associated with an item. The unique identifier of the smart fabric may be an embedded unique identifier that is assigned to the corresponding item at the time of the manufacturing process and logged in the service computing system. The service computing system may be a server associated with a particular brand (e.g., a luxury brand) and configured to log all the unique identifiers of each manufactured item and data associated therewith.

The service computing system is configured to receive a verification request. The verification request may be generated from any device, such as (but not limited to) a mobile device, a piece of smart fabric, and/or a verification and authentication device. The verification request contains at least one of (1) a unique identifier of a piece of smart fabric associated with an item among the plurality of items, or (2) a unique identifier of a verification and authentication device associated with the item. The service computing system is also configured to determine whether the identifier of the piece of smart fabric and/or the identifier of the verification and authentication device are associated with a record among the plurality of records. In response to determining that the identifier of the piece of smart fabric and/or the identifier of the verification and authentication device are associated with a record, the service computing system is configured to automatically and/or dynamically generate a token for authentication of the item and cause the token to be received by the verification and authentication device.

In response to receiving the token, the verification and authentication device is caused to transmit data associated with the token to the piece of smart fabric, which in turn transmits the data associated with the token to the mobile device. In some embodiments, data associated with the token is a hash code generated by hashing the token based on a predetermined hash function.

In some embodiments, the piece of smart fabric includes a grid of capacitive sensors with embedded near field communication (NFC) devices. The piece of smart fabric is configured to receive a code (e.g., token, data associated with the token, or a hash code generated by hashing the token) from the verification and authentication device via a contact connector, and store the code in the grid of capacitive sensors by selectively turning on one or more capacitive sensors in the grid. The piece of smart fabric is also configured to transmit the code stored in the grid of capacitive sensors via the embedded NFC devices to a mobile device.

In response to receiving the data associated with the token from the piece of smart fabric, the mobile device sends the received data to the service computing system. In response to receiving the data from the mobile device, the service computing system determines whether the data associated with the token received from the mobile device corresponds to the token generated by the service computing system. In response to determining that the data received from the mobile device corresponds to the token generated by the service computing system, the service computing system sends a verification response to the mobile device, indicating that the item is an authentic item.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not, therefore, to be considered to be limiting in scope, embodiments will be described and explained with additional specificity and details through the use of the accompanying drawings in which:

FIG. 1 illustrates an example system including an item with a piece of smart fabric fixed thereon, a verification and authentication device, a mobile device, and a service computing system that implement the principles described herein;

FIG. 2 illustrates an example embodiment of a smart fabric corresponding to the smart fabric of FIG. 1;

FIG. 3 illustrates another example embodiment of a smart fabric corresponding to the smart fabric of FIG. 1;

FIG. 4 illustrates an example architecture of a verification and authentication device corresponding to the verification and authentication device of FIG. 1;

FIG. 5 illustrates an example architecture of a mobile device corresponding to the mobile device of FIG. 1;

FIG. 6 illustrates an example architecture of a service computing system corresponding to the service computing system of FIG. 1;

FIG. 7 illustrates an example communication pattern that may be performed among a piece of smart fabric, a verification and authentication device, a mobile device, and a service computing system, corresponding to the system of FIG. 1;

FIG. 8 illustrates a flowchart of an example method for registering a new record with a service computing system corresponding to the service computing system of FIG. 1;

FIG. 9 illustrates a flowchart of an example method for verifying whether an item is an authentic item via a service computing system corresponding to the service computing system of FIG. 1;

FIG. 10 illustrates a flowchart of an example method for changing ownership of an item via a service computing system corresponding to the service computing system of FIG. 1;

FIG. 11 illustrates a flowchart of an example method for receiving, by a verification and authentication device, a token from a service computing system for authentication of an item associated with a piece of smart fabric and the verification and authentication device;

FIG. 12 illustrates a flowchart of an example method for receiving, by a piece of smart fabric, a code from a verification and authentication device and transmitting the code to a mobile device for authentication of an item associated with the piece of smart fabric and the verification and authentication device; and

FIG. 13 illustrates an example computing system in which the principles described herein may be employed.

### DETAILED DESCRIPTION

The principles described herein are related to a system including a piece of smart fabric embedded in an item (e.g., a luxury good), a verification and authentication device, a service computing system, and/or a mobile device for allowing the verification of whether the item is an authentic item.

The service computing system has access to a plurality of records associated with a plurality of items. Each item has a piece of smart fabric fixed thereon. Each of the plurality of records is configured to store at least a unique identifier of a piece of smart fabric and a unique identifier of a verification and authentication device associated with an item. The unique identifier of the smart fabric may be an embedded unique identifier that is assigned to the corresponding item at the time of the manufacturing process and logged in the service computing system. The service computing system may be a server associated with a particular brand (e.g., a luxury brand) and configured to log all the unique identifiers of each manufactured item and data associated therewith.

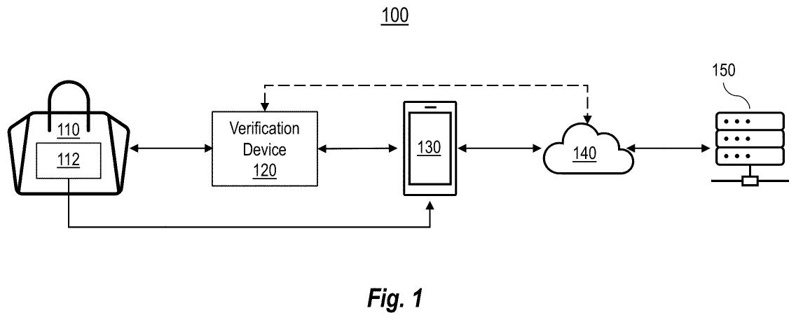

FIG. 1 illustrates an example of a system 100 that implements the principles described herein. As illustrated, the system 100 includes a smart fabric 112 coupled to (e.g., embedded in) an item 110. The system 100 also includes a verification and authentication device 120 and/or a mobile device 130. The system 100 also includes a service computing system 150 configured to keep records of items and verify the authenticity of these items. The service computing system 150 is configured to communicate with the mobile device 130 via a network 140. In some embodiments, the verification and authentication device 120 is also configured to communicate with the service computing system 150 via the network 140.

The verification and authentication device 120 and the piece of the smart fabric 112 are associated with each other and configured to be connected to each other. In some embodiments, the verification and authentication device 120 is a removable dongle, and the piece of smart fabric 112 includes a receptacle or an interface configured to receive the verification and authentication device 120. In some embodiments, the verification and authentication device 120 is configured to be permanently attached to the piece of the smart fabric 112. When the verification and authentication device 120 is connected to the piece of smart fabric 112, the verification and authentication device 120 is configured to power the piece of smart fabric 112, allowing the piece of smart fabric to generate sensing data and transmit the sensing data to the mobile device 130.

In some embodiments, the piece of smart fabric 112 includes a grid of capacitive sensors with embedded near field communication (NFC) devices. In some embodiments, the grid of capacitive sensors in the smart fabric 112 is configured to receive a touch input from a user. In some embodiments, the touch input is a patterned swipe gesture traversing a predetermined sequence of capacitive sensors in the grid. In some embodiments, the swipe gesture is registered with the verification and authentication device 120, the mobile device 130, and/or a record of the item 110 stored at the service computing system 150 that is accessible by the verification and authentication device and/or the mobile device. In some embodiments, in response to determining that the touch input received by the piece of smart fabric 112 matches the registered touch input, the smart fabric 112 is turned onto a verification mode.

In some embodiments, in the verification mode, the smart fabric 112 is configured to receive a code from a verification and authentication device via a contact connector and store the code in the grid of capacitive sensors by selectively turning on one or more capacitive sensors in the grid. The piece of smart fabric 112 is also configured to transmit the code stored in the grid of capacitive sensors via the embedded NFC devices to the mobile device 130.

The service computing system 150 includes or has access one or more computer-readable hardware storage devices, having stored thereon a plurality of records associated with a plurality of items. Each item has a piece of smart fabric fixed thereon. Each of the plurality of records is configured to store at least a unique identifier of a piece of smart fabric and a unique identifier of a verification and authentication device associated with an item. The service computing system 150 is configured to receive a verification request from the mobile device 130. The mobile device 130 is configured to communicate with the verification and authentication device 120 to obtain an identification of the verification and authentication device 120 and/or an identification of the piece of smart fabric 112. The mobile device 130 is also configured to generate and send a verification request to the service computing system 150 to verify whether the item is authentic. The verification request contains at least one of (1) a unique identifier of a piece of smart fabric associated with an item among the plurality of items, or (2) a unique identifier of a verification and authentication device associated with the item.

In response to receiving the verification request, the service computing system 150 determines whether the identifier of the piece of smart fabric 112 and/or the identifier of the verification and authentication device 120 are associated with a record among the plurality of records. In response to determining that the identifier of the piece of smart fabric 112 and/or the identifier of the verification and authentication device 120 are associated with a record, the service computing system 150 is configured to automatically and/or dynamically generate a token for authentication of the item and causes the token to be received by the verification and authentication device 120. In some embodiments, the token is valid for a predetermined time.

After receiving the token, the verification and authentication device 120 is configured to transmit data associated with the token to the piece of smart fabric 112. In some embodiments, the data associated with the token is a code. In some embodiments, the code may be the token, a portion of the token, and/or a hash code hashed from the token. In the embodiments, in which the code is a hash code, the verification and authentication device 120 is configured to hash the token into the hash code having a fixed length based on a predetermined hash function. Receiving the code from the verification and authentication device, the piece of smart fabric 112 transmits the code to the mobile device 130. The mobile device 130 then sends the data associated with the token to the service computing system 150. The service computing system 150 is configured to determine whether the code received from the mobile device 130 corresponds to the token generated by itself. In response to determining that the code received from the mobile device corresponds to the token generated by the service computing system 150, the service computing system 150 sends a verification response to the mobile device 130, indicating that the item 110 is authentic.

In some embodiments, the service computing system 150 is further configured to receive a registration request for registering a particular item having fixed thereon a particular piece of smart fabric and associated with a particular verification and authentication device. The registration request contains a unique identifier of the particular piece of smart fabric and a unique identifier of the particular verification and authentication device. The service computing system 150 is configured to associate the item with the particular piece of smart fabric and the particular verification and authentication device and generate a new record storing one or more attributes of the item, the identifier of the verification and authentication device, and the identifier of the piece of smart fabric relationally.

In some embodiments, each record further includes a field for storing information about one or more owners of a corresponding item. In some embodiments, the service computing system 150 is configured to receive an ownership change request from a mobile device 130 for changing ownership of the item to a new owner. The ownership change request contains at least one of (1) the identifier of the piece of smart fabric, and/or (2) the identifier of the verification and authentication device. The service computing system 150 is further configured to determine that the identifier of the piece of smart fabric and/or the identifier of the verification and authentication device is associated with a record among the plurality of records. In response to determining that the identifier of the piece of smart fabric or the identifier of the verification and authentication device is associated with a record, the service computing system 150 automatically and/or dynamically generates a token and sends the token to the verification and authentication device 120.

Similar to the verification process described above, receiving the token, the verification and authentication device 120 is configured to send data associated with the token (e.g., a code) to the particular piece of smart fabric, which in turn transmits the code to the mobile device. The mobile device 130 then sends the code to the service computing system 150. Receiving the code from the mobile device, the service computing system 150 determines that the code received from the mobile device corresponds to the token generated by itself. In response to determining that the code received from the mobile device corresponds to the token generated by itself, the service computing system 150 records information about the new owner in the record.

In some embodiments, in response to determining that the identifier of the piece of smart fabric and/or the identifier of the verification and authentication device 120 are associated with a record among the plurality of records, the service computing system 150 is further configured to retrieve information about a current owner of the item, and generate a consent request to a mobile device associated with the current owner. When the mobile device associated with the current owner receives the consent request, the user (i.e., the current owner) can choose to interact with the mobile device to consent or not consent to the request. In response to receiving a consent response from the mobile device of the current owner, the service computing system 150 can then record the information about the new owner in the record.

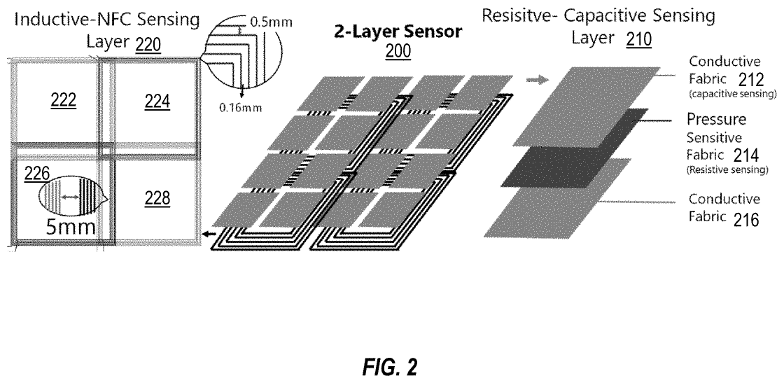

FIG. 2 illustrates an example piece of smart fabric 200 that corresponds to the piece of smart fabric 112 of FIG. 1. As illustrated in FIG. 2, the piece of smart fabric 200 includes (1) a first layer 210 (also referred to as the “resistive-capacitive sensing layer”) having multiple resistive sensors and multiple capacitive sensors, and (2) a second layer 220 (also referred to as the “inductive-NFC sensing layer”) having multiple inductive sensors and multiple NFC devices. Each of the multiple resistive sensors corresponds to each of the multiple NFC devices, respectively. Each of the multiple inductive sensors corresponds to each of the multiple NFC devices, respectively.

In some embodiments, in the first layer 210, each of the multiple capacitive sensors includes a first piece of conductive fabric 212 and a second piece of conductive fabric 216. In some embodiments, the conductive fabric 212, 216 includes non-metallic conductive fabric, such as a conductive polymer. Each of the multiple resistive sensors includes a piece of pressure sensing fabric 214, such as Velostat. In some embodiments, each piece of pressure sensing fabric 214 of the resistive sensor is sandwiched between the first piece of conductive fabric 212 and the second piece of conductive fabric 216 of the corresponding capacitive sensor. Each piece of the conductive fabric 212, 216, and each piece of pressure sensing fabric 214 serves as an electrode. The rows and columns of electrodes 212, 216 of the capacitive sensors are electrically separated, while the rows and columns of electrodes 214 of the resistive sensors are electrically connected. As illustrated, the resistive sensors and the capacitive sensors are arranged in a grid of 4×4, though the invention is not limited to this structure. For example, a greater number of capacitive sensors and/or resistive sensors (e.g., a grid of 4×8, 8×8, 16×16, 32×32, 64×64, etc.) may also be implemented.

The second layer 220 includes multiple coils 222, 224, 226, 228 configured to act as both inductor coils for the multiple inductive sensors and sensor coils for the multiple NFC devices. In some embodiments, every two adjacent coils among the plurality of coils overlap each other. Because an operation may become unreliable when the inductance of the coils is below 4 uH, it is advantageous to implement the coils 222, 224, 226, 228 to have an inductance of at least 4 uH, and about 5 or more traces are preferred. As illustrated, four coils are arranged in a grid of 2×2, and each coil is rectangular-shaped or square-shaped and has about 5 traces, though the invention is not limited to this structure. For example, a different shape of coils (e.g., circular-shaped) or a greater number of coils (e.g., a grid of 2×4, 4×4, 8×8, 16×16, 32×32, 64×64, etc.) may also be implemented.

Each of the multiple capacitive sensors is configured to sense touch input. Each of the multiple resistive sensors is configured to sense pressure based on the change in the resistance of a pressure-sensitive material (such as piezo-resistive material) when it is pressed or deformed. Thus, the resistive sensors are also configured to sense touch input.

Each of the multiple NFC devices uses alternating electromagnetic fields for receiving and transmitting data. When an NFC device is triggered by an electromagnetic interrogation signal from a nearby antenna coil, it transmits its data to the sensor coil. In some embodiments, each NFC device includes a coil that is laid out in a particular manner, such that the NFC device not only can detect tags, but also can function as an inductive sensor.

Note, although the smart fabric 200 illustrated in FIG. 2 includes capacitive sensors and inductive sensors, the capacitive sensors and the inductive sensors are not required. In some embodiments, the smart fabric 200 only includes a layer of capacitive sensors and a layer of NFC devices. Further, it is also not necessary that a grid of 2×2 capacitive sensors corresponds to one NFC device.

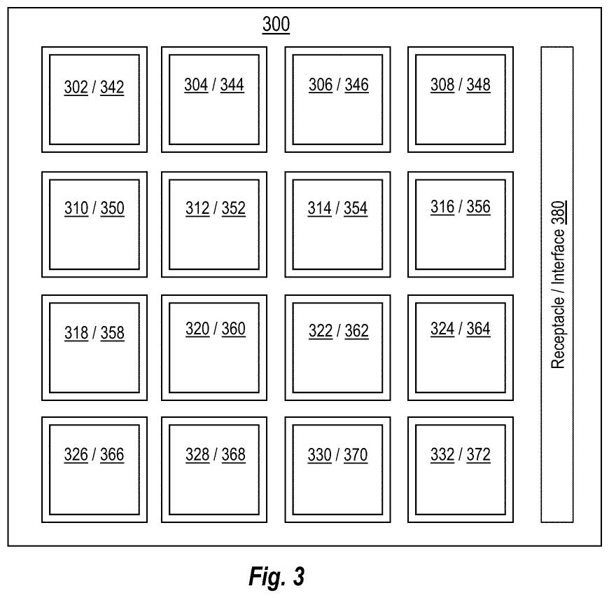

FIG. 3 illustrates another example piece of smart fabric 300 that also corresponds to the smart fabric 112. As illustrated, the piece of smart fabric 300 only includes a capacitive sensing layer, an NFC layer, and a receptacle or an interface configured to be connected to a verification and authentication device 120. The capacitive sensing layer includes a grid of 4×4 capacitive sensors 302, 304, 306, 308, 310, 312, 314, 316, 318, 320, 322, 324, 326, 328, 330, and 332. The NFC sensing layer includes a grid of 4×4 NFC devices 342, 344, 346, 348, 350, 352, 354, 356, 358, 360, 362, 364, 366, 368, 370, and 372. As illustrated, each of the capacitive sensors 302, 304, 306, 308, 310, 312, 314, 316, 318, 320, 322, 324, 326, 328, 330, and 332 corresponds to one of the NFC devices 342, 344, 346, 348, 350, 352, 354, 356, 358, 360, 362, 364, 366, 368, 370, and 372. Again, different shaped grids may be implemented to achieve the same or similar purposes, such as a grid of 2×4, 8×8, 16×16, 32×32, or 64×64 may be implemented in different embodiments. Generally, the greater the grid, the more secure of verification the smart fabric 300 can provide.

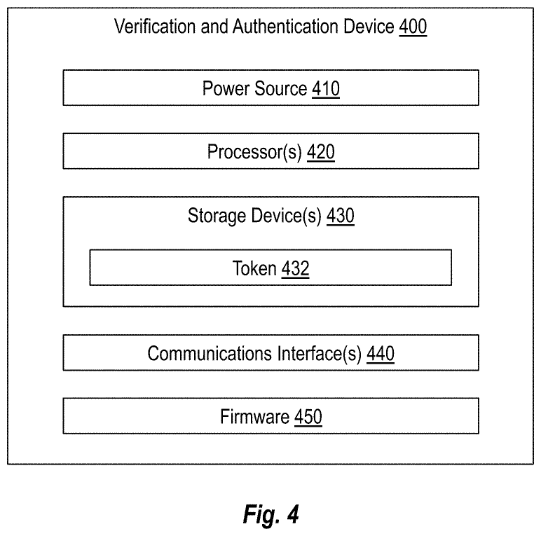

FIG. 4 illustrates an example architecture of a verification and authentication device 400 that corresponds to the verification and authentication device 120 of FIG. 1. The verification and authentication device 400 includes a power source 410, one or more processors 420, one or more storage devices 430, and one or more communication interfaces 440. In some embodiments, the verification and authentication device 400 has its firmware 450 installed on the one or more storage devices 430, the firmware 450 is configured to allow the verification and authentication device 400 to communicate with the smart fabric 112, 200, or 300, the mobile device 130, and/or the service computing system 150. In some embodiments, the firmware 450 is also configured to cause the one or more processors 420 to hash received tokens into hash codes and transmit the hash codes to a connected smart fabric 112.

The power source 410 is configured to power the one or more processors 420 and storage devices 430. When the verification and authentication device 400 is connected to a piece of smart fabric 112, the verification and authentication device 400 is configured to power the sensors embedded on the smart fabric 112. Further, the one or more storage devices 430 is not only configured to store the firmware 450, but also configured to store token 432 received from the service computing system 150 and/or a code (e.g., a hash code) generated from the token 432. The one or more communication interfaces 440 includes an interface configured to be connected to the receptacle or interface 380 of the smart fabric 300. In some embodiments, the one or more communication interfaces 440 also includes a wireless communication interface (e.g., a Bluetooth low energy interface) configured to be connected to a mobile device (e.g., the mobile device 130 of FIG. 1). In some embodiments, the one or more communication interface 440 also includes a wireless communication interface (e.g., a Wi-Fi interface, a 2G, 3G, 4G, and/or 5G interface) configured to connect to a service computing system (e.g., the service computing system 150 of FIG. 1) directly. In some embodiments, the verification and authentication device 400 also includes a display (including touch or non-touch display) and one or more buttons configured to allow a user to directly interact with the verification and authentication device 400.

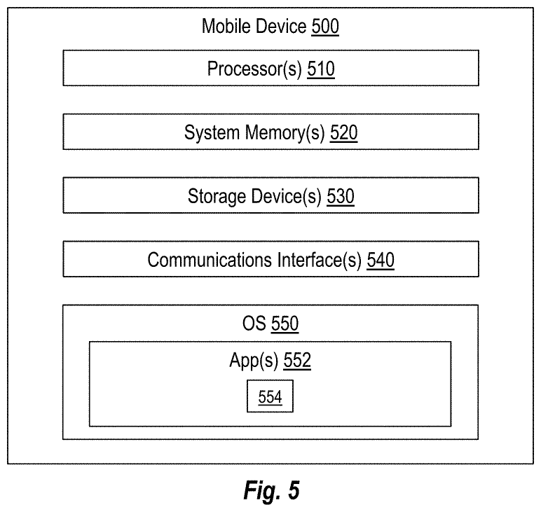

FIG. 5 illustrates an example architecture of a mobile device 500 that corresponds to the mobile device 130 of FIG. 1. The mobile device includes one or more processors 510, one or more system memories 520, one or more storage devices 530, and one or more communications interfaces 540. In some embodiments, the one or more communication interfaces 540 includes a first wireless communication interface (e.g., a Wi-Fi interface, a 2G, 3G, 4G, and/or 5G interfaces) configured to communicate with a service computing system (e.g., service computing system 150 of FIG. 1). In some embodiments, the one or more communication interfaces 540 also includes a second wireless communication interface (e.g., NFC interface) configured to communicate with NFC devices embedded in a piece of smart fabric (e.g., smart fabric 112, 200, and/or 300). In some embodiments, the one or more communication interfaces 540 also includes a third wireless communication interface (e.g., a Bluetooth low energy interface) configured to communicate with a verification and authentication device (e.g., verification and authentication device 120 and/or 400).

In some embodiments, the mobile device 500 has an operating system 550 installed on the one or more storage devices 530 and loaded into the one or more system memories 520. In some embodiments, the mobile device 500 also includes one or more applications 552 installed on the one or more storage devices 530. One of the one or more applications 552 is an authentication application 554 that allows the mobile device 500 to communicate with the verification and authentication device 120, 400, the smart fabric 112, 200, 300, and/or the service computing system 150, 600. In some embodiments, the authentication application 554 is configured to receive a unique identifier of the verification and authentication device 120, 400 and/or a unique identifier of the smart fabric 112, 200, 300 from the verification and authentication device 120, 400, and generate and send a verification request to the service computing system 150 and/or 600. In some embodiments, the authentication application 554 also allows the mobile device to receive a code from smart fabric (e.g., smart fabric 112, 200, and/or 300), send the code to a service computing system (e.g., the service computing system 150 of FIG. 1), and receive a verification response from the service computing system.

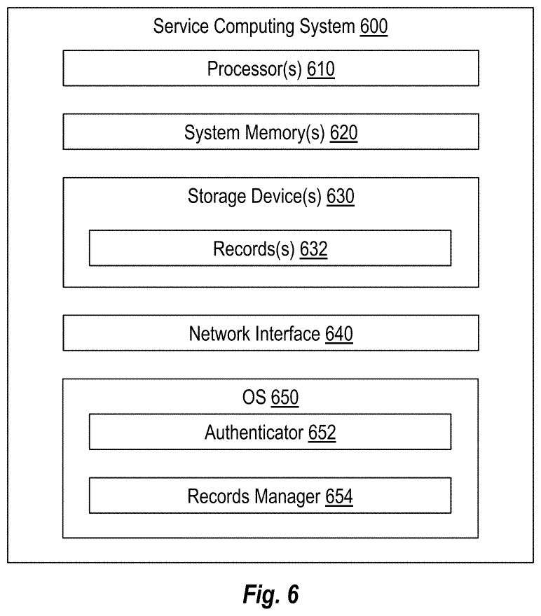

FIG. 6 illustrates an example architecture of a service computing system 600 that corresponds to the service computing system 150 of FIG. 1. The service computing system 600 includes one or more processors 610, one or more system memories 620, one or more storage devices 630, and a network interface 640. In some embodiments, the service computing system has an operating system 650 installed on the one or more storage devices 630 and loaded into the one or more system memories 620. The one or more storage devices 630 not only store the operating system 650 but also store one or more records 632 of items. The service computing system 600 also includes a datasets manager 654 configured to manage the one or more datasets 632. Further, the service computing system also includes authenticator 652 configured to generate tokens and verify whether an item is authentic in response to receiving a verification request.

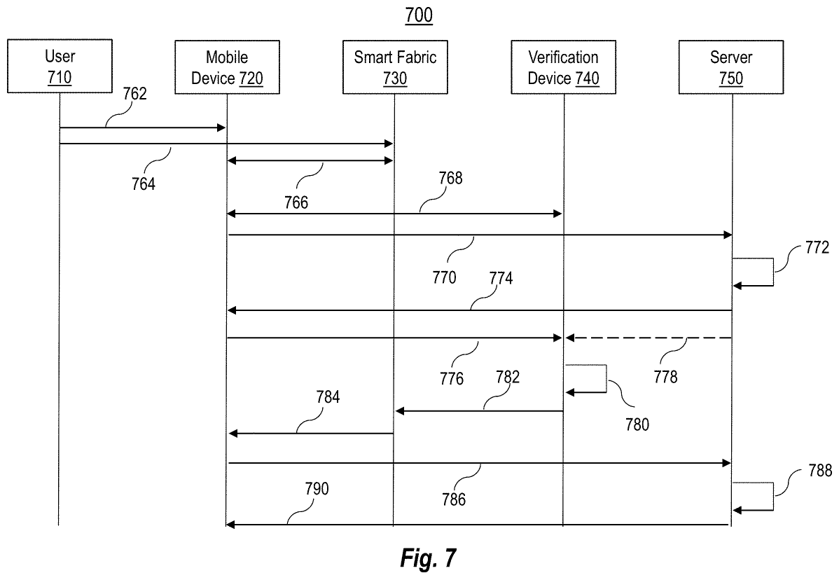

FIG. 7 illustrates an example of a communication pattern 700 among a user 710, a mobile device 720 (corresponding to mobile device 130 and/or 500), a piece of smart fabric 730 (corresponding to smart fabric 112, 200, and/or 300), a verification and authentication device 740 (corresponding to verification and authentication device 120 and/or 400), and a server 750 (corresponding to the service computing system 150 and/or 600). As illustrated, the user 710 interacts with the mobile device 720, which is represented by arrow 762. For example, in some embodiments, the interaction with the mobile device 720 causing the mobile device to execute an authentication application (e.g., the authentication application 554). In some embodiments, the user 710 can also interact with the smart fabric 730, which is represented by arrow 764. In some embodiments, the user 710 can perform a touch gesture (e.g., a swipe gesture), traversing a sequence of one or more capacitive sensors in a grid. In response to the touch gesture, the smart fabric 730 is configured to send the received touch gesture to the mobile device 720, which is represented by arrow 766. Further, the mobile device 720 is also configured to communicate with the verification and authentication device 740, which is represented by arrow 768. In some embodiments, the mobile device 720 is configured to pair with the verification and authentication device 740 via a personal area network (e.g., Bluetooth low energy network). In some embodiments, the verification and authentication device 740 is configured to send a unique identifier of the smart fabric 730 and/or a unique identifier of the verification and authentication device 740 to the mobile device 720.

Thereafter, the mobile device 720 is configured to generate and send a verification request to the server 750, which is represented by arrow 770. In some embodiments, the verification request contains at least one of (1) the identifier of the smart fabric 730 and/or (2) the identifier of the verification and authentication device 740. In response to receiving the verification request, the server 750 determines whether the identifier of the smart fabric 730 and/or the identifier of the verification and authentication device 740 are associated with a record among a plurality of records stored at the server 750 or accessible by the server 750, which is represented by arrow 772. In response to determining that the identifier of the smart fabric 730 and/or the identifier of the verification and authentication device 740 are associated with a record, the server 750 automatically and/or dynamically generates a token and causes the token to be received by the verification and authentication device 740, which may be represented by arrows 774, 776, and/or 778. In some embodiments, the verification and authentication device 740 includes a wireless interface configured to communicate with the server 750 directly. In such a case, the server 750 is configured to send the token directly to the verification and authentication device 740, which is represented by arrow 778. In some embodiments, the server 750 is configured to send the token to the mobile device first, which is represented by arrow 774, and the mobile device 720 is configured to pass the received token to the verification and authentication device 740, which is represented by arrow 776.

In some embodiments, receiving the token, the verification and authentication device 740 is configured to hash the token into a hash code having a fixed length based on a predetermined hash function, such as (but not limited to) SHA-2, which is represented by arrow 780. The verification and authentication device 740 then transmits the hash code to the smart fabric 730, which is represented by arrow 782. The smart fabric 730 then transmits the hash code to the mobile device 720, which is represented by arrow 784. Receiving the hash code from the smart fabric 730, the mobile device 720 sends the received hash code to the server 750, which is represented by arrow 786. Receiving the hash code, the server 750 is configured to verify whether the hash code was generated from the token, which is represented by arrow 788. In some embodiments, the server 750 hashes the token generated by itself based on the predetermined hash function to generate a hash code, and compares the hash code generated by itself with the hash code received from the mobile device 720 to determine whether they match. In response to determining that the hash code generated by itself and the hash code received from the mobile device 720 match, the server 750 sends a verification response to the mobile device 720, indicating that the item associated with the smart fabric 730 and the verification and authentication device 740 is an authentic item, which is represented by arrow 790.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

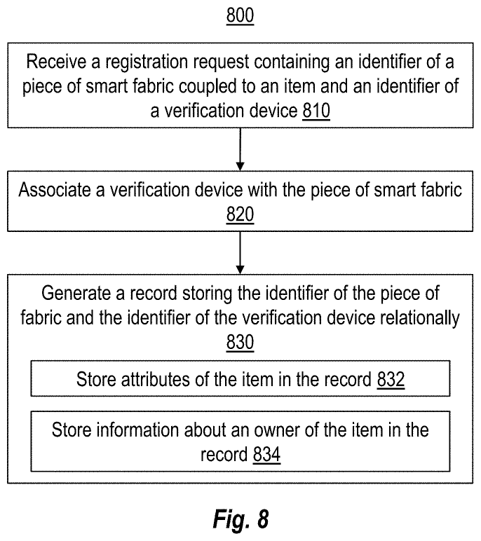

FIG. 8 illustrates a flowchart of an example method 800 for generating a record of an item coupled to a piece of smart fabric corresponding to the smart fabric 112, 200, and/or 300), which may be performed by a service computing system corresponding to the service computing system 150 and/or 600. The method 800 includes receiving a registration request containing a unique identifier of the piece of smart fabric and a unique identifier of a verification and authentication device (corresponding to the verification and authentication device 120, 400) (act 810) and associating the verification and authentication device with the piece of smart fabric (act 820). The method 800 also includes generating a record storing the identifier of the piece of smart fabric and the identifier of the verification and authentication device relationally (act 830). The unique identifier of the smart fabric may be an embedded unique identifier that is assigned to the corresponding item at the time of the manufacturing process and logged in the service computing system. The service computing system may be a server associated with a particular brand (e.g., a luxury brand) and configured to log all the unique identifiers of each manufactured item and data associated therewith.

In some embodiments, the record also stores attributes of the item (act 832). For example, if the item is a luxury handbag, the style, color, and/or one or more pictures of the handbag may all be stored in the record with the identifier of the smart fabric and the identifier of the verification and authentication device. In some embodiments, the record also stores information about an owner of the item (act 834). In some embodiments, an owner field in the record is initially left empty. In some embodiments, an original owner of the item is set as a manufacture or a distributor of the item. For example, when the original owner is a retail store, the retail store's information (such as the store name, street address, website, and/or contact information) is entered into the record when the record is generated.

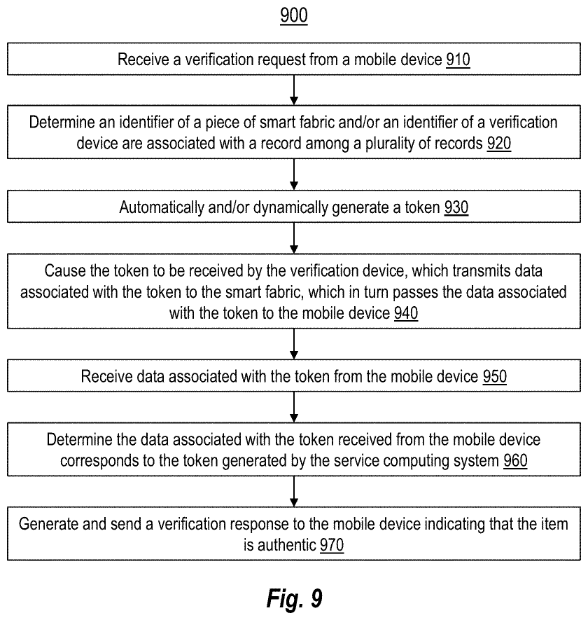

FIG. 9 illustrates a flowchart of an example method 900 for verifying whether an item (corresponding to the item 110 of FIG. 1, fixed thereon a piece of smart fabric corresponding to the smart fabric 112) is an authentic item, which may also be performed by the service computing system 150 and/or 600. The method 900 includes receiving a verification request from a mobile device (act 910). The mobile device corresponds to the mobile device 130 and/or 500. The mobile device is configured to communicate with a verification and authentication device to obtain a unique identifier of the verification and authentication device and/or a unique identifier of a piece of smart fabric associated with the item. In embodiments, the verification request contains the identifier of the verification and authentication device and/or the identifier of the smart fabric. The method 900 includes determining whether the identifier of the piece of the smart fabric and/or the identifier of the verification and authentication device are associated with a record among a plurality of records at the service computing system (act 920).

In response to determining that the identifier of the piece of the smart fabric and/or the identifier of the verification and authentication device are associated with a record, the service computing system automatically and/or dynamically generates a token (act 930) and cause the token to be received by the verification and authentication device (act 940). In some embodiments, the verification and authentication device includes a communications interface configured to communicate with the service computing system directly. In such a case, the service computing system sends the token to the verification and authentication device directly. In some embodiments, the service computing system sends the token to the mobile device, causing the mobile device to pass the token to the verification and authentication device. In response to receiving the token, the verification and authentication device transmits data associated with the token to the piece of smart fabric, which in turn passes the data associated with the token to the mobile device. In some embodiments, data associated with the token is a hash code. The verification and authentication device is configured to hash the token into a hash code having a fixed length based on a predetermined hash function, and send the hash code to the piece of the smart fabric, and the piece of the smart fabric is configured to transmit the hash code to the mobile device.

In response to receiving the data associated with the token from the piece of smart fabric, the mobile device sends the data associated with the token to the service computing system. The method 900 also includes receiving data associated with the token from the mobile device (act 950). In response to receiving the data associated with the token, the service computing system determines whether the data associated with the token received from the mobile device corresponds to the token generated by the service computing system (act 960). In response to determining that the data associated with the token corresponds to the token generated by the service computing system (act 960), the service computing system generates and sends a verification response to the mobile device, indicating that the item is authentic (act 970).

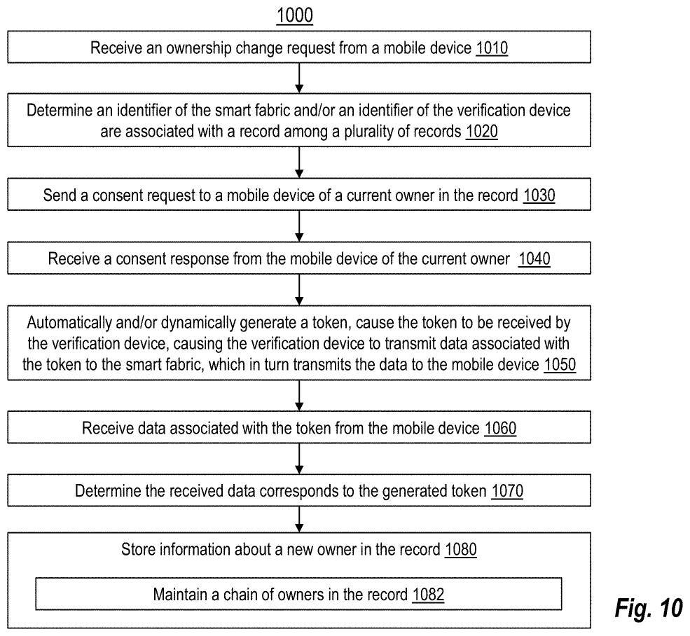

FIG. 10 illustrates a flowchart of an example method 1000 for updating ownership of an item in a record stored at and/or accessible by a service computing system corresponding to the service computing system 150 and/or 600, which may be performed by the service computing system. For example, when a retail store sells an item to a customer, the owner of the item needs to be changed from the retail store to the customer. The method 1000 includes receiving an ownership change request from a mobile device (act 1010). In some embodiments, the request is sent by a mobile device of a new owner via the authentication application 554. In some embodiments, the mobile device is configured to be connected (e.g., paired with) the verification and authentication device and receive a unique identifier of the smart fabric and/or a unique identifier of the verification and authentication device from the verification and authentication device. Based on the received identifier of the smart fabric and identifier of the verification and authentication device, the mobile device generates the ownership change request containing the identifier of the smart fabric and/or the identifier of the verification and authentication device. Receiving the ownership change request, the service computing system determines whether the identifier of the smart fabric and/or the identifier of the verification and authentication device are associated with a record among a plurality of records (act 1020).

In some embodiments, in response to determining that the identifier of the smart fabric and/or the identifier of the verification and authentication device are associated with a record, the service computing system retrieves information about a current owner of the item in the record and sends a consent request to a mobile device of a current owner of the item (act 1030). In some embodiments, the mobile device of the current owner of the item is configured to receive the consent request via the authentication application 554. Receiving the consent request, the current owner may generate an input indicating consent or not consent. When the current owner consents to the request, the service computing system receives a consent response from the mobile device of the current owner (act 1040).

In some embodiments, the service computing system further automatically and/or dynamically generates a token and causes the token to be received by the verification and authentication device. The verification and authentication device is then caused to send data associated with the token (also referred to as a code) to the smart fabric, which in turn transmits the code to the mobile device (act 1050). In response to receiving the code, the mobile device is configured to send the code to the service computing system, which may also be performed via the authentication application 554. In response to receiving the code from the mobile device (act 1060), the service computing system then determines whether the received code corresponds to the generated token (act 1070). In response to determining that the received code matches the generated token (act 1070), the service computing system stores information about a new owner in the record (act 1080). In some embodiments, the service computing system overwrites information about a previous owner with the information about the new owner. Alternatively, the service computing system maintains a chain of owners in the record (act 1082).

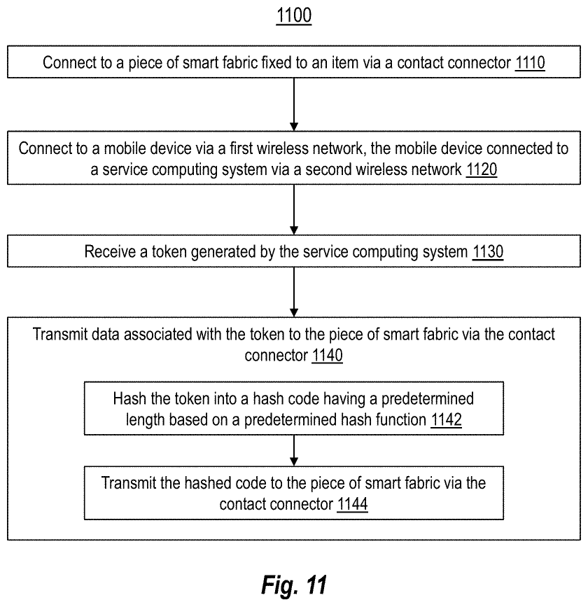

FIG. 11 illustrates a flowchart of an example method 1100 for receiving, by a verification and authentication device (corresponding to the verification and authentication device 120 and/or 400), a token from a service computing system for authentication of an item associated with a piece of smart fabric (corresponding to the smart fabric 112, 200, and/or 300) and the verification and authentication device 400. The method 1100 (which may be performed by a verification and authentication device 400) includes connecting to a piece of smart fabric fixed to an item via a contact connector 1110. The method 1100 also includes connecting to a mobile device via a first wireless network (e.g., Bluetooth low energy network) (act 1120). The mobile device is connected to a service computing system via a second wireless network (e.g., Wi-Fi, 2G, 3G, 4G, and/or 5G). The method 1100 further includes receiving a token generated by the service computing system (act 1130). In some embodiments, the token generated by the service computing system is first received by the mobile device, which in turn passes the token to the verification and authentication device. Alternatively, the token generated by the service computing system is received by the verification and authentication device from the service computing system directly.

The method 1100 also includes transmitting data associated with the token to the piece of smart fabric via the contact connector (act 1140). In some embodiments, act 1140 further includes hashing the token into a hash code having a predetermined length based on a predetermined hash function (act 1142) and transmitting the hashed code (which corresponds to the data associated with the token) to the piece of smart fabric via the contact connector (act 1144).

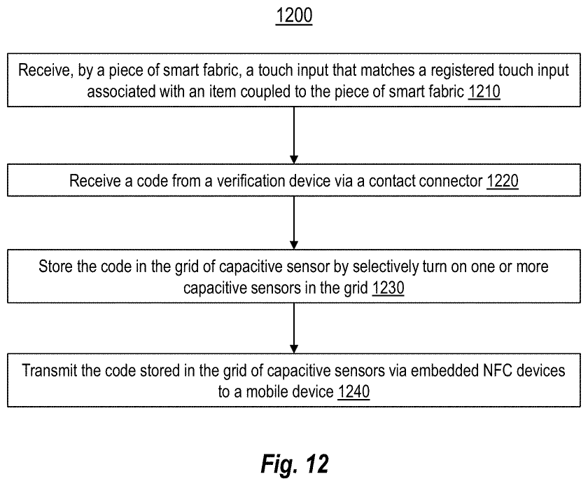

FIG. 12 illustrates a flowchart of an example method for receiving, by a piece of smart fabric (corresponding to the smart fabric 112, 200, and/or 300), a code from a verification and authentication device (corresponding to the verification and authentication device 120 and/or 400) and transmitting the code to a mobile device (corresponding to the mobile device 130 and/or 500) for authentication of an item associated with the piece of the smart fabric and the verification and authentication device. The piece of smart fabric includes a grid of capacitive sensors with embedded near field communication (NFC) devices. The method 1200 (which may be performed by a piece of smart fabric 300) includes receiving, by the piece of smart fabric, a touch input that matches a registered touch input associated with an item coupled to the piece of smart fabric (act 1210). The method 1200 also includes receiving a code from a verification and authentication device via a contact connector (act 1220). The method 1200 also includes storing the code in the grid of capacitive sensor by selectively turn on one or more capacitive sensors in the grid (act 1230) and transmitting the code stored in the grid of capacitive sensors via embedded NFC devices to a mobile device (act 1240).

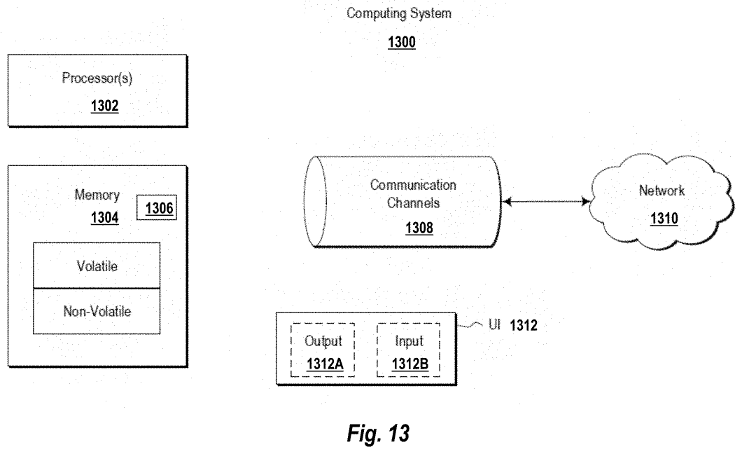

Finally, because the principles described herein may be performed in the context of a computing system (for example, each of verification and authentication device 120, 400, mobile device 130, 500, and service computing system 150, 600 may include one or more computing systems) some introductory discussion of a computing system will be described with respect to FIG. 13.

Computing systems are now increasingly taking a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 13, in its most basic configuration, a computing system 1300 typically includes at least one hardware processing unit 1302 and memory 1304. The processing unit 1302 may include a general-purpose processor and may also include a field-programmable gate array (FPGA), an application-specific integrated circuit (ASIC), or any other specialized circuit. The memory 1304 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 1300 also has thereon multiple structures often referred to as an “executable component.” For instance, memory 1304 of the computing system 1300 is illustrated as including executable component 1306. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component.”

The term “executable component” is also well understood by one of ordinary skill as including structures, such as hardcoded or hardwired logic gates, that are implemented exclusively or near-exclusively in hardware, such as within a field-programmable gate array (FPGA), an application-specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine,” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description above, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied in one or more computer-readable media that form a computer program product. An example of such an operation involves the manipulation of data. If such acts are implemented exclusively or near-exclusively in hardware, such as within an FPGA or an ASIC, the computer-executable instructions may be hardcoded or hardwired logic gates. The computer-executable instructions (and the manipulated data) may be stored in the memory 1304 of the computing system 1300. Computing system 1300 may also contain communication channels 1308 that allow the computing system 1300 to communicate with other computing systems over, for example, network 1310.

While not all computing systems require a user interface, in some embodiments, the computing system 1300 includes a user interface system 1312 for use in interfacing with a user. The user interface system 1312 may include output mechanisms 1312A as well as input mechanisms 1312B. The principles described herein are not limited to the precise output mechanisms 1312A or input mechanisms 1312B as such will depend on the nature of the device. However, output mechanisms 1312A might include, for instance, speakers, displays, tactile output, holograms, and so forth. Examples of input mechanisms 1312B might include, for instance, microphones, touchscreens, holograms, cameras, keyboards, mouse or other pointer input, sensors of any type, and so forth.

Embodiments described herein may comprise or utilize a special purpose or general-purpose computing system, including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special purpose computing system, or special purpose processing device to perform a certain function or group of functions. Alternatively or in addition, the computer-executable instructions may configure the computing system to perform a certain function or group of functions. The computer-executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including personal computers, desktop computers, laptop computers, message processors, handheld devices, multi-processor systems, microprocessor-based or programmable consumer electronics, network PCs, minicomputers, mainframe computers, mobile telephones, PDAs, pagers, routers, switches, data centers, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The remaining figures may discuss various computing system which may correspond to the computing system 1300 previously described. The computing systems of the remaining figures include various components or functional blocks that may implement the various embodiments disclosed herein, as will be explained. The various components or functional blocks may be implemented on a local computing system or may be implemented on a distributed computing system that includes elements resident in the cloud or that implement aspect of cloud computing. The various components or functional blocks may be implemented as software, hardware, or a combination of software and hardware. The computing systems of the remaining figures may include more or less than the components illustrated in the figures, and some of the components may be combined as circumstances warrant. Although not necessarily illustrated, the various components of the computing systems may access and/or utilize a processor and memory, such as processing unit 1302 and memory 1304, as needed to perform their various functions.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A service computing system comprising:
one or more processors; and
one or more computer-readable hardware storage devices having stored thereon a plurality of records associated with a plurality of items, each item having a piece of smart fabric fixed thereon, each of the plurality of records storing at least a unique identifier of a piece of smart fabric and a unique identifier of a verification and authentication device associated with an item, and computer-executable instructions that are structured such that, when executed by the one or more processors, configure the service computing system to perform at least:
receive a verification request from a mobile device, the verification request containing at least one of (1) a unique identifier of a piece of smart fabric associated with an item among the plurality of items, or (2) a unique identifier of a verification and authentication device associated with the item;
in response to determining that the identifier of the piece of smart fabric or the identifier of the verification and authentication device is associated with a record among the plurality of records, generate a token for authentication of the item; and
cause the token to be received by the verification and authentication device, causing the verification and authentication device to transmit data associated with the token to the piece of smart fabric, which in turn transmits the data associated with the token to the mobile device;
receive the data associated with the token from the mobile device;
in response to determining that the data associated with the token received from the mobile device corresponds to the token generated by the service computing system, send a verification response to the mobile device, indicating that the item is an authentic item.

2. The service computing system of claim 1, wherein the token is valid for a predetermined time.

3. The service computing system of claim 1, wherein causing the token to be received by the verification and authentication device comprises sending the token to the mobile device and causing the mobile device to pass the token to the verification and authentication device.

4. The service computing system of claim 3, wherein the verification and authentication device is configured to hash the token into a hash code based on a predetermined hash function, and transmit the hash code to the piece of smart fabric, and the service computing system is further configured to:
receive the hash code from the mobile device;
hash the token to a hash code based on the predetermined hash function;
in response to determining that the hash code hashed by the service computing system matches the hash code received from the mobile device, send the verification response to the mobile device.

5. The service computing system of claim 1, the service computing system further configured to:
receive a registration request for registering a particular item having fixed thereon a particular piece of smart fabric and a particular verification and authentication device, the registration request containing a unique identifier of the particular piece of smart fabric and a unique identifier of the particular verification and authentication device;
associate the item with the particular piece of smart fabric and the particular verification and authentication device; and
generate a new record storing one or more attributes of the item, the identifier of the verification and authentication device, and the identifier of the piece of smart fabric relationally;

6. The service computing system of claim 1, wherein each record includes a field for storing information about one or more owners of a corresponding item.

7. The service computing system of claim 6, the service computing system further configured to:
receive an ownership change request from a mobile device for changing ownership of the item to a new owner, the ownership change request containing at least one of (1) the identifier of the piece of smart fabric, or (2) the identifier of the verification and authentication device;
in response to determining that the identifier of the piece of smart fabric or the identifier of the verification and authentication device is associated with a record among the plurality of records, generate a second token;
send the second token to the verification and authentication device, causing the verification and authentication device to send data associated with the second token to the piece of smart fabric, which in turn transmits the data associated with the second token to the mobile device;
receive the data associated with the second token from the mobile device;
in response to determining that the data associated with the second token received from the mobile device corresponds to the second token generated by the service computing system, record information about the new owner in the record.

8. The service computing system of claim 7, wherein in response to determining that the identifier of the piece of smart fabric or the identifier of the verification and authentication device is associated with a record among the plurality of records,
retrieve information about a current owner of the item;
generate a consent request to a mobile device associated with the current owner;
in response to receiving a consent response from the mobile device of the current owner, record the information about the new owner in the record.

9. The service computing system of claim 7, wherein the verification and authentication device is configured to hash the second token into a second hash code based on a predetermined hash function, and transmit the second hash code to the piece of smart fabric, and the service computing system is further configured to:
receive the second hash code from the mobile device;
hash the second token to a second hash code based on the predetermined hash function;
in response to determining that the second hash code hashed by the service computing system matches the second hash code received from the mobile device, record the information about the new owner in the record.

10. The service computing system of claim 7, wherein the record of the item further contains a chain of owners that have owned the item.

11. The service computing system of claim 1, wherein the piece of smart fabric includes a grid of capacitive sensors configured to receive a touch input;
the service computing system is further configured to:
register a patterned swipe gesture that traverses a predetermined sequence of one or more capacitive sensors in the grid in the record of the item;
in response to receiving a patterned swipe gesture that traverses a sequence of one or more capacitive sensors in the grid, determine whether the sequence of the one or more capacitive sensors in the grid matches the patterned swipe gesture registered in the record;
in response to determining that the sequence of the one or more capacitive sensor matches the patterned swipe gesture registered in the record, generate the token.

12. A verification and authentication device configured to be connected to a piece of smart fabric coupled to an item, the verification and authentication device comprising:
one or more processors; and
one or more computer-readable hardware storage devices having stored thereon computer-executable instructions that are structured such that, when executed by the one or more processors, configure the verification and authentication device to perform at least:
connect to a piece of smart fabric coupled to an item via a contact connector;
connect to a mobile device via a first wireless network, the mobile device also connected to a service computing system via a second wireless network causing the service computing system to generate a token;
receive the token generated by the service computing system;
transmit data associated with the token to the piece of smart fabric via the contact connector, causing the smart fabric to transmit the data associated with the token to the mobile device.

13. The verification and authentication device of claim 12, further comprising a power source configured to provide power to the piece of smart fabric via the contact connector.

14. The verification and authentication device of claim 12, further configured to:
hash the token to a hash code based on a predetermined hash function, the hash code being the data associated with the token; and
transmit hash code to the piece of smart fabric via the contact connector, causing the smart fabric to transmit the hash code to the mobile device.

15. The verification and authentication device of claim 12, wherein the token is valid for a predetermined time.

16. A piece of smart fabric coupled to an item, comprising a grid of capacitive sensors with embedded near field communication (NFC) devices, the piece of smart fabric configured to:
receive a code from a verification and authentication device via a contact connector;
store the code in the grid of capacitive sensors by selectively turning on one or more capacitive sensors in the grid; and
transmit the code stored in the grid of capacitive sensors via the embedded NFC devices to a mobile device.

17. The piece of smart fabric of claim 16, wherein the grid of capacitive sensors is further configured to receive a touch input from a user; and
in response to receiving the touch input, the piece of smart fabric selectively turns on the one or more capacitive sensors in the grid based on the code.

18. The piece of smart fabric of claim 17, wherein the touch input is a patterned swipe gesture traversing a predetermined sequence of capacitive sensors in the grid.

19. The piece of smart fabric of claim 18, wherein the patterned swipe gesture is registered with the verification and authentication device, the mobile device, or a record of the item stored at a service computing system that is accessible by the verification and authentication device or the mobile device, and in response to determining that the touch input matches the patterned swipe gesture that is registered, the piece of smart fabric is caused to selectively turn on the one or more capacitive sensors in the grid based on the code.

20. The piece of smart fabric of claim 16, wherein the code is a hash code generated by the verification and authentication device, the verification and authentication device configured to hash a token, generated by a service computing system, into the hash code based on a predetermined hash function.
